(19) United States
(12) Patent Application Publication
(10) Pub. No.: US 2026/0200207 A1
(43) Pub. Date: Jul. 16, 2026

(54) LAMINATES COMPRISING LIGHT-BLOCKING SUBSTRATES

(71) Applicant: PPG Advanced Surface Technologies, LLC, New Albany, OH (US)

(72) Inventor: Helge Warta, Ditzingen (DE)

(73) Assignee: PPG Advanced Surface Technologies, LLC, New Albany, OH (US)

(21) Appl. No.: 19/134,011

(22) PCT Filed: Dec. 7, 2023
(86) PCT No.: PCT/US2023/082825

§ 371 Date: May 29, 2025

Related U.S. Application Data
(60) Provisional application No. 63/386,398, filed on Dec. 7, 2022.

(51) Int. Cl. B32B 7/023; B32B 3/26; B32B 5/18; B32B 27/06; B32B 27/20

(52) U.S. Cl. CPC B32B 7/023; B32B 3/266; B32B 5/18; B32B 27/065; B32B 27/20; B32B 2250/02; B32B 2255/10; B32B 2264/10; B32B 2266/0214; B32B 2307/41; B32B 2307/7376; B32B 2605/00

(57) ABSTRACT

The present disclosure relates to a laminate substrate for use in automotive applications comprising (a) substrate, and (b) a light-blocking substrate, a method of preparing such laminate substrates, a method for preparing a molded laminate substrate and such molded laminate substrates.

### FIELD

The present disclosure relates to a laminate substrate for use in automotive applications comprising (a) a substrate, and (b) a light-blocking substrate, a method of preparing such laminate substrates, a method for preparing a molded laminate substrate, and to such molded laminate substrates.

### BACKGROUND

In automotive applications it is often desirable to provide components that can be backlit, allowing light to pass through the component and especially through transparent areas of the component. The transparent areas may be colored so that day-time and night-time designs of the component can be achieved. If the illumination at night should deviate from the day-time design of the transparent areas, additional shielding, such as light blocking from the back of the component, is required. This is usually solved with a print on the rear side of the component by screen printing. The print typically comprises a first black layer print and a subsequent second white layer print directly onto each other. The black layer print acts as a shield (e.g., light-blocking layer) and the white layer print as a reflective layer. However, such application of the additional shielding has several disadvantages. The screen-printing inks have extended drying times of up to three hours at high temperatures, such as 80° C. The entire component must pass through a dryer to coat only portions of the component. Moreover, the component must be placed on the side that will be viewed by an observer, which risks scratching or otherwise damaging the observed side. Another disadvantage is that an additional manufacturing step is necessary for printing.

Thus, it would be desirable to provide laminate substrates and a method for preparing laminate substrates preventing the above-described disadvantages.

This is achieved by the subject matter in the appended claims. It has surprisingly been found that long drying times are not necessary and the front of the component (observed side) is not compromised by work performed on the opposing side. Moreover, the laminate substrate of the present disclosure avoids an additional working step of screen-printing print layers on the component, as the preparation can be performed in one step, e.g., lamination can be performed with molding of the component. Also, no additional energy is required for the lamination step, as the waste heat for molding can be used.

### SUMMARY

The present disclosure is directed to a laminate substrate for use in automotive applications comprising (a) a substrate (a); and (b) a light-blocking substrate (b) comprising (i) a porous substrate (i), and (ii) a pigmented coating (ii) applied on the porous substrate (i); wherein the light-blocking substrate (b) is applied on a part of a surface of the substrate (a) with the pigmented coating (ii) facing the surface of the substrate (a).

The present disclosure is also directed to a method for preparing a laminate substrate comprising applying a light-blocking substrate (b) on a part of a surface of a substrate (a), wherein the light-blocking substrate (b) comprises (i) a porous substrate (i), and (ii) a pigmented coating (ii) applied on the porous substrate (i); and wherein the light-blocking substrate (b) is applied on the surface of a substrate (a) with the pigmented coating (ii) facing the surface of the substrate (a).

The present disclosure further relates to a laminate substrate prepared by the method for preparing a laminate substrate as described above.

Moreover, the present disclosure is directed to a method for preparing a molded laminate substrate comprising thermoforming the laminate substrate as described above or prepared by the method for preparing a laminate substrate described above.

Further, the present disclosure is directed to a molded laminate substrate prepared by the method for preparing a molded laminate substrate as described above.

### FIGURES

FIG. 1 (not to scale) shows a schematic cross-section of a laminate substrate according to the present disclosure. The laminate substrate comprises a substrate (a) and a light-blocking substrate (b). The light-blocking substrate (b) comprises a porous substrate (i), and a pigmented coating (ii) applied on the porous substrate (i). The light-blocking substrate (b) is applied on a part of a surface of the substrate (a) with the pigmented coating (ii) facing the surface of the substrate (a).

FIG. 2 (not to scale) shows a schematic cross-section of a laminate substrate according to the present disclosure. The laminate substrate comprises a substrate (a) and a light-blocking substrate (b). The light-blocking substrate (b) comprises a porous substrate (i), an additional pigmented coating (iii) applied on the porous substrate (i), and a pigmented coating (ii) applied on the additional pigmented coating (iii). The light-blocking substrate (b) is applied on a part of a surface of the substrate (a) with the pigmented coating (ii) facing the surface of the substrate (a).

FIG. 3 (not to scale) shows a schematic cross-section of a laminate substrate according to the present disclosure. The laminate substrate comprises a substrate (a); and a light-blocking substrate (b). The light-blocking substrate (b) comprises a porous substrate (i), an additional pigmented coating (iii) applied on the porous substrate (i), and a pigmented coating (ii) applied on the additional pigmented coating (iii). The light-blocking substrate (b) further comprises perforations that go through the porous substrate (i), the additional pigmented coating (iii), and the pigmented coating (ii). The light-blocking substrate (b) is applied on a part of a surface of the substrate (a) with the pigmented coating (ii) facing the surface of the substrate (a).

FIG. 4 (not to scale) shows a schematic cross-section of a laminate substrate according to the present disclosure. The laminate substrate comprises a substrate (a); a light-blocking substrate (b); and a plastic layer (c). The light-blocking substrate (b) comprises a porous substrate (i), an additional pigmented coating (iii) applied on the porous substrate (i), and a pigmented coating (ii) applied on the additional pigmented coating (iii). The light-blocking substrate (b) is applied on a part of a surface of the substrate (a) with the pigmented coating (ii) facing the surface of the substrate (a) and the light-blocking substrate (b) is applied on a part of a surface of the plastic layer (c) with the porous substrate (i) facing the surface of the plastic layer (c).

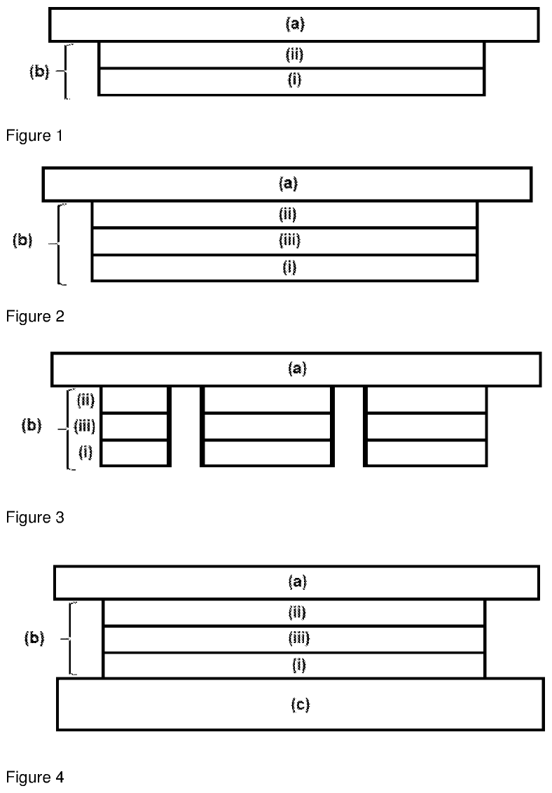

### DETAILED DESCRIPTION

For purposes of the following detailed description, it is to be understood that the disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” polymer, “a” pigment, and the like refer to one or more of any of these items. “Including” and the like terms mean “including but not limited to”. Similarly, as used herein, the terms “on” and “applied on” a surface mean applied on but not necessarily in contact with the surface.

The terms “resin,” “resinous,” and the like are used interchangeably with the terms “polymer,” “polymeric,” and the like. Further, the term “polymer” is used herein in its common meaning in the art, referring to macromolecular compounds, i.e., compounds having a relatively high molecular weight (e.g., 500 Da or more), the structure of which comprises multiple repetition units (also referred to as “mers”) derived, actually or conceptually, from chemical species of relatively lower molecular mass. Unless indicated otherwise, molecular weights are on a weight average basis (“M_{w}”) and are determined by gel permeation chromatography using polystyrene standards.

The present disclosure relates to a laminate substrate for use in automotive applications comprising (a) a substrate, and (b) a light-blocking substrate. The light-blocking substrate (b) comprises (i) a porous substrate (i), and (ii) a pigmented coating (ii) applied on the porous substrate (i). The light-blocking substrate (b) is applied on a part of a surface of the substrate (a) with the pigmented coating (ii) facing the surface of the substrate (a). Such application of the light-blocking substrate (b) on the substrate (a) results in a laminate structure comprising a layer sequence of substrate (a), pigmented coating (ii), and porous substrate (i).

As used herein, the term “porous substrate” refers to a substrate having a network of interconnecting pores. The porous substrate may include a microporous substrate.

According to the present disclosure, the porous substrate (i) may comprise a polyolefin, a polyester, a polyamide, a polyurethane, a polyurea, a polycarbonate, a polysiloxane, a poly(meth)acrylate, a copolymer thereof or a mixture thereof. The porous substrate (i) may comprise a thermoplastic polymer. The thermoplastic polymer may comprise a polyolefin, a polyester, a polyamide, a polyurethane, a polyurea, a polycarbonate, a polysiloxane, a poly(meth)acrylate, a copolymer thereof or a mixture thereof.

According to the present disclosure, suitable polyesters may be prepared in a known manner, e.g., by condensation of a polyol and a polyacid or by ring-opening polymerization of lactones. As used herein, the term “polyol” refers to a compound having more than one hydroxyl group per molecule, e.g., 2, 3, 4, 5, 6 or more hydroxyl groups per molecule, and the term “polyacid” refers to a compound having more than one carboxylic acid group per molecule, e.g., 2, 3, 4, 5, 6 or more carboxylic acid groups per molecule, and includes anhydrides of the corresponding acid. Suitable polyols include, but are not limited to, alkylene glycols, such as ethylene glycol, propylene glycol, butylene glycol, 1,6-hexylene glycol, diethylene glycol, dipropylene glycol, triethylene glycol, tripropylene glycol, polyethylene glycol, polypropylene glycol, polybutylene glycol and neopentyl glycol; bisphenol A; hydrogenated bisphenol A; bisphenol F; hydrogenated bisphenol F; cyclohexandiol; propanediols such as 1,2-propanediol, 1,3-propanediol, butyl ethyl propanediol, 2-methyl-1,3-propanediol and 2-ethyl-2-butyl-1,3-propanediol; butanediols such as 1,4-butanediol, 1,3-butanediol, 2,3-butanediols, 1,2-butanediols, 3-methyl-1,2-butanediol and 2-ethyl-1,4-butanediol; pentanediols such as 1,2-pentanediol, 1,5-pentanediol, 1,4-pentanediol, 3-methyl-4,5-pentanediol and 2,2,4-trimethyl-1,3-pentanediol; hexanediols such as 1,6-hexanediol, 1,5-hexanediol, 1,4-hexanediol and 2,5-hexanediol; poly(caprolactone)diols; polyether glycols, such as poly(oxytetramethylene) glycol; trimethylolpropane; pentaerythritol; dipentaerythritol; trimethylolethane; trimethylolbutane; dimethylolcyclohexane and glycerol. Suitable polyacids may include, but are to limited to, maleic acid; fumaric acid; itaconic acid; adipic acid; azelaic acid; succinic acid; sebacic acid; glutaric acid; phthalic acid; isophthalic acid; 5-tert-butylisophthalic acid; tetrachlorophthalic acid; trimellitic acid; naphthalene dicarboxylic acid; naphthalene tetracarboxylic acid; terephthalic acid, hexahydrophthalic acid; methyl hexahydrophthalic acid; dimethyl terephthalic acid; cyclohexane dicarboxylic acid, 1,3-cyclohexane dicarboxylic acid; 1,4-cyclohexane dicarboxylic acid; tricyclodecanepolycarboxylic acid, endomethylenetetrahydrophthalic acid; endoethylenehexahydrophthalic acid; cyclohexane tetracarboxylic acid; cyclobutanetetracarboxylic acid and anhydrides of all the aforementioned polyacids. Suitable lactones may include, but are not limited to, β-propiolactone; γ-butyrolactone; δ-valerolactone; ε-caprolactone; α-angelica lactone; and mixture thereof.

Suitable polyamides may be prepared in a known manner, e.g., by polymerizing a polyamine and a polyacid or by ring-opening polymerization of lactams. Herein, the term “polyamine” refers to a compound having more than one amine group per molecule, e.g., 2, 3, 4, 5, 6, or more amine groups per molecule. Suitable polyamines include, but are not limited to, aliphatic diamines such as 1,2-ethanediamine, 1,2-propanediamine, 1,3-propanediamine, 1,2-butanediamine, 1,3-butanediamine, 1,4-butanediamine, 1,3-pentanediamine, 1,5-pentanediamine, 1,6-hexanediamine, 2-methyl-1,5-pentanediamine, 2,5-dimethylhexane-2,5-diamine, 2,2,4-trimethyl-1,6-hexanediamine, 2,4,4-trimethyl-1,6-hexanediamine, 1,7-heptanediamine, 1,8-octanediamine, 1,9-nonanediamine and 1,10-decanediamine; cycloaliphatic diamines such as 2,4′-diamino dicyclohexylmethane, 4,4′-diamino dicyclohexylmethane, 3,3′-dimethyl-4,4′-diamino dicyclohexylmethane and 3,3′-diethyl-4,4′-diaminodicyclohexylmethane; and aromatic diamines such as 1,2-benzenediamine, 1,3-benzenediamine, 1,4-benzenediamine, 1,5-naphthalenediamine, 1,8-naphthalenediamine, 2,4-toluenediamine, 2,5-toluenediamine, 2,6-toluenediamine, and 3,3′-dimethyl-4,4′-biphenyldiamine. Non-limiting examples of suitable polyacids may include those listed above for preparing polyesters. Suitable lactams may include, but are not limited to, β-propiolactam; γ-butyrolactam; δ-valerolactam; ε-caprolactam; and mixture thereof.

Suitable polyurethanes can be prepared in a known manner, e.g., by reacting a polyisocyanate and a polyol. As used herein, the term “polyisocyanate” refers to a compound having more than one isocyanate group per molecule, e.g., 2, 3, 4, 5, 6, or more isocyanate groups per molecule. Suitable polyisocyanates include aliphatic polyisocyanates, such as 2,2,4-trimethyl hexamethylene diisocyanate, 2,4,4-trimethyl hexamethylene diisocyanate, 1,6-hexamethylene diisocyanate; cycloaliphatic polyisocyanates, such as isophorone diisocyanate and 4,4′-methylene-bis(cyclohexyl isocyanate); aromatic polyisocyanates such as 4,4′-diphenylmethane diisocyanate, toluene diisocyanate, 1,2,4-benzene triisocyanate, tetramethyl xylylene diisocyanate and polymethylene polyphenyl isocyanate. Non-limiting examples of suitable polyols may be the polyols described above for producing the polyesters.

Suitable polyureas can be prepared in a known manner, e.g., by reacting a polyisocyanate and a polyamine. Non-limiting examples of suitable polyisocyanates may be the polyisocyanates described above for producing the polyurethanes. Non-limiting examples of suitable polyamines may be the polyamines described above for producing the polyamides.

Suitable polycarbonates may be prepared in a known manner, e.g., by condensation of a diol and phosgene or by ring-opening polymerization of cyclic carbonates. Suitable diols may include, but are not limited to, alkylene glycols; bisphenol A; hydrogenated bisphenol A; bisphenol F; hydrogenated bisphenol F; cyclohexandiol; propanediols such as 1,2-propanediol, 1,3-propanediol, butyl ethyl propanediol, 2-methyl-1,3-propanediol and 2-ethyl-2-butyl-1,3-propanediol; butanediols such as 1,4-butanediol, 1,3-butanediol, 2,3-butanediols, 1,2-butanediols, 3-methyl-1,2-butanediol and 2-ethyl-1,4-butanediol; pentanediols such as 1,2-pentanediol, 1,5-pentanediol, 1,4-pentanediol, 3-methyl-4,5-pentanediol and 2,2,4-trimethyl-1,3-pentanediol; hexanediols such as 1,6-hexanediol, 1,5-hexanediol, 1,4-hexanediol and 2,5-hexanediol; and poly(caprolactone)diols. Suitable cyclic carbonates may include, but are not limited to, ethylene carbonate, and propylene carbonate.

Suitable polysiloxanes may include, but are not limited to, alkyl substituted polysiloxanes, aryl polysiloxanes, copolymers, blends and mixtures thereof. The alkyl substitution may be selected from short chain alkyl groups of 1 to 4 carbon atoms, such as methyl or propyl. The aryl substitution may comprise phenyl groups.

Suitable poly(meth)acrylates may be homopolymers or copolymers, which can be obtained by polymerizing one or more monomers comprising substituted or unsubstituted (meth)acrylic acids and (meth)acrylates. Herein, the terms “(meth)acrylic acid” and “(meth)acrylate” and similar terms refer both to the acrylic acid or acrylate and the corresponding methacrylic acid or methacrylate, respectively. Suitable (meth)acrylates can include, but are not limited to, alkyl (meth)acrylates, cycloalkyl (meth)acrylates, alkylcycloalkyl (meth)acrylates, aralkyl (meth)acrylates, alkylaryl (meth)acrylates, aryl (meth)acrylates and functional groups-containing (meth)acrylates. As used herein, the term “functional group” refers to a group that includes one or a plurality of atoms other than hydrogen and sp³ carbon atoms. Examples of functional groups include, but are not limited to, hydroxyl, carboxylic acid, amido, isocyanate, urethane, thiol, amino, sulfone, sulfoxide, phosphine, phosphite, phosphate, halide, and the like. Non-limiting examples of poly(meth)acrylates may include acrylic resins derived from methyl (meth)acrylate, ethyl (meth)acrylate, propyl (meth)acrylate, butyl (meth)acrylate, iso-butyl (meth)acrylate, 2-ethyl hexyl (meth)acrylate, iso-octyl (meth)acrylate, isobornyl (meth)acrylate, isodecyl (meth)acrylate, lauryl (meth)acrylate, tridecyl (meth)acrylate, tetradecyl (meth)acrylate, hexadecyl (meth)acrylate, octadecyl (meth)acrylate, stearyl (meth)acrylate, benzyl (meth)acrylate, 2-phenoxyethyl (meth)acrylate, 3,3,5-trimethyl-cyclohexyl (meth)acrylate, 3-methylphenyl (meth)acrylate, 1-naphtyl (meth)acrylate, 3-phenyl-n-propyl (meth)acrylate, 2-phenyl-aminoethyl (meth)acrylate, hydroxyethyl (meth)acrylate, hydroxypropyl (meth)acrylate, 4-hydroxybutyl (meth)acrylate, glycidyl (meth)acrylate or combinations thereof.

Suitable polyolefins may be homopolymers or copolymers, which can be obtained by polymerizing one or more monomers comprising substituted or unsubstituted ethylene, tetrafluoroethylene, propylene, butene, pentene, hexene, octene, or mixtures thereof. Suitable examples of polyolefin may comprise polyethylene, poly(tetrafluoroethylene), polypropylene, polybutylene, copolymers of ethylene and propylene, copolymers of ethylene and acrylic acid, copolymers of ethylene and methacrylic acid, copolymers or mixtures thereof. Suitable examples of polyolefin may comprise polyethylene, polypropylene, polybutylene, copolymers or mixtures thereof.

According to the present disclosure, the porous substrate (i) may comprise a polyolefin. The thermoplastic polymer may comprise a polyolefin.

The porous substrate (i) may comprise an inorganic filler. The inorganic filler may be water insoluble. The inorganic filler may comprise silica, alumina, calcium oxide, zinc oxide, magnesium oxide, titanium oxide, zirconium oxide, or a mixture thereof. According to the present disclosure, the inorganic filler may comprise silica. Suitable examples of silica may include, but are not limited to, precipitated silica, silica gel, fumed silica or combinations thereof.

The inorganic filler can constitute from 10 to 90 percent by weight, such as from 15 to 90 percent by weight, or from 20 to 90 percent by weight, or from 25 to 90 percent by weight, or 30 to 90 percent by weight, or 40 to 90 percent by weight of the porous substrate.

The porous substrate may comprise a network of interconnecting pores communicating throughout the porous substrate. Such pores can comprise at least 5 percent by volume, e.g. from at least 5 to 95 percent by volume, or from at least 15 to 95 percent by volume, or from at least 20 to 95 percent by volume, or from at least 25 to 95 percent by volume, or from 35 to 70 percent by volume of the porous substrate. On a treatment-free, coating free, or impregnant-free basis, such pores can comprise at least 5 percent by volume, e.g. from at least 5 to 95 percent by volume, or from at least 15 to 95 percent by volume, or from at least 20 to 95 percent by volume, or from at least 25 to 95 percent by volume, or from 35 to 70 percent by volume of the porous substrate.

The porosity of the porous substrate, expressed as percent by volume, may be determined according to the following equation:

$$Porosity = 100 [ \frac{1 - {d}_{1}}{{d}_{2}} ]$$

wherein d₁ is the density of the sample, which is determined from the sample weight and the sample volume as ascertained from measurements of the sample dimensions, and d₂ is the density of the solid portion of the sample, which is determined from the sample weight and the volume of the solid portion of the sample. The volume of the solid portion of the sample is determined using a Quantachrome Stereopycnometer (Quantachrome Corp.) in accordance with the accompanying operating manual.

The porous substrate may comprise pores having a volume average diameter of at least 0.001 μm, such as at least 0.050 μm, or at least 0.10 μm, or at least 0.15 μm, or at least 0.20 μm, or at least 0.25 μm, or at least 0.30 μm, or at least 0.35 μm. The porous substrate may comprise pores having a volume average diameter of 0.90 μm or less, such as 0.85 μm or less, or 0.80 μm or less, or 0.75 μm or less, or 0.70 μm or less, or 0.65 μm or less, or 0.60 μm or less. The porous substrate may comprise pores having a volume average diameter in a range between any of the above-mentioned values such as from 0.001 to 0.70 μm, or from 0.30 to 0.70 μm.

The volume average diameter of the pores of the porous substrate can be determined by mercury porosimetry using an Autopore III porosimeter (Micromeretics, Inc.) in accordance with the accompanying operating manual. The volume average pore radius for a single scan is automatically determined by the porosimeter. In operating the porosimeter, a scan is made in the high-pressure range (from 138 kPa absolute to 227 MPa absolute). If approximately 2 percent or less of the total intruded volume occurs at the low end (from 138 to 250 kPa absolute) of the high-pressure range, the volume average pore diameter is taken as twice the volume average pore radius determined by the porosimeter. Otherwise, an additional scan is made in the low-pressure range (from 7 to 165 kPa absolute) and the volume average pore diameter is calculated according to the equation:

$$d = \frac{2 [ \frac{{v}_{1} + {r}_{1}}{{w}_{1}} + \frac{{v}_{2} {r}_{2}}{{w}_{2}} ]}{[ \frac{{v}_{1}}{{w}_{1}} + \frac{{v}_{2}}{{w}_{2}} ]}$$

wherein d is the volume average pore diameter, v₁ is the total volume of mercury intruded in the high-pressure range, v₂ is the total volume of mercury intruded in the low-pressure range, r₁ is the volume average pore radius determined from the high-pressure scan, r₂ is the volume average pore radius determined from the low-pressure scan, w₁ is the weight of the sample subjected to the high-pressure scan, and w₂ is the weight of the sample subjected to the low-pressure scan.

The porous substrate (i) may be prepared by mixing a mixture comprising, e.g., an inorganic filler; and a polyolefin, a polyester, a polyamide, a polyurethane, a polyurea, a polycarbonate, a polysiloxane, a poly(meth)acrylate, a copolymer thereof or a mixture thereof, such as a polyolefin, until a substantially uniform mixture is obtained. The mixture may be extruded and a porous substrate may be formed by extruding the mixture in a die, such as a sheeting die, to form a desired end shape.

The porous substrate (i) may have a thickness of at least 10 μm, such as at least 20 μm, or at least 40 μm, or at least 50 μm, or at least 70 μm, or at least 80 μm, or at least 100 μm. The porous substrate (i) may have a thickness of 620 μm or less, such as 600 μm or less, or 590 μm or less, or 580 μm or less, or 570 μm or less, or 560 μm or less, or 550 μm or less. The porous substrate (i) may have a thickness in a range between any of the above-mentioned values such as from 100 μm to 600 μm, or from 100 μm to 580 μm, or from 100 μm to 550 μm. The thickness can be determined according to ASTM D-374-16. The porous substrate may be a sheet or a film.

The porous substrate may comprise a white coloration. The porous substrate (i) may have a whiteness index of at least 70%, such as at least 75%, or at least 80%, as determined according to ASTM E313-20.

Suitable examples of a porous substrate may include, but are not limited to, substrates commercially available under the trademark Teslin®, such as the Teslin TS series (Teslin TS600, Teslin TS700, Teslin TS800, Teslin TS1000, Teslin TS 1200, Teslin TS1400), the Teslin SP series (Teslin SP600, Teslin SP700, Teslin SP800, Teslin SP1000, Teslin SP1200, Teslin SP1400, Teslin SP1800), the Teslin HD series (Teslin HD1400, Teslin HD1800), commercially available from PPG Industries (Ohio).

According to the present disclosure, the light-blocking substrate (b) may further comprise an additional pigmented coating (iii) between the porous substrate (i) and the pigmented coating (ii). If present, the additional pigmented coating (iii) can be applied on the porous substrate (i), and the pigmented coating (ii) can be applied on the additional pigmented surface (iii). The additional pigmented coating (iii) may be applied on the entire surface of the porous substrate (i) or the additional pigmented coating (iii) may be applied only on defined parts of the surface of the porous substrate (i). The additional pigmented coating (iii) may not be applied on the entire surface of the porous substrate (i). If the additional pigmented coating (iii) is present, the pigmented coating (ii) may be applied on the entire surface of the additional pigmented coating (iii) or the pigmented coating (ii) may be applied on defined parts of the surface of the additional pigmented coating (iii). The pigmented coating (ii) may not be applied on the entire surface of the additional pigmented coating (iii).

According to the present disclosure, the additional pigmented coating (iii) may comprise poly(meth)acrylate, polyolefin, polyester, polysiloxane, epoxy resin, polyurethane, polyamide, polycarbonate, polyisocyanate, polyol, a copolymer thereof, or a mixture thereof.

Suitable examples of a poly(meth)acrylate, a polyolefin, a polyester, a polysiloxane, a polyurethane, a polyamide, a polycarbonate, polyisocyanate, or polyol may be as one as described above. Suitable examples of polyurethane and copolymer thereof include, but are not limited to, polyurethanes as described in, e.g., EP 0 260 447 A1, EP 0 089 497 A1, EP 0 256 540 A1, EP 0 297 576 A1, WO 96/12747, EP 0 228 003 A1, EP 0 397 806 A1, EP 0 574 417 A1, EP 0 531 510 A1, EP 0 581 211 A1 or EP 0 708 788 A1. Moreover, suitable examples of polyurethanes include, but are not limited to the reaction product of NCO-functional polyurethanes with OH-functional compounds such as with OH-functional polyesters, as described, e.g., in WO 2011/120940 A1. Especially suitable are polyurethanes derivable from an OH-functional component A containing double bonds, an NCO-functional component B containing double bonds, and optionally a component C containing double bonds as described in WO 2009/024310 A2, especially on page 3, first paragraph to page 5, fourth paragraph of WO 2009/024310 A2. Component A may be a polyol, and component Band C may be urethane acrylates.

Suitable epoxy resins may be prepared in a known manner, e.g., by reacting a compound comprising at least one epoxide functionality and a cyclic co-reactant comprising at least two hydroxyl groups. Examples of suitable compounds comprising one epoxide functionality include, but are not limited to, glycidol; epichlorohydrin; glycidol amines and mixtures thereof. As used herein, the terms “epoxy” and “epoxide” are used interchangeably. Examples of suitable cyclic co-reactants comprising at least two hydroxy groups include, but are not limited to, bisphenol A; hydrated bisphenol A; bisphenol F; hydrated bisphenol F; novolac resins such as phenolic novolac, cresol novolac; and mixtures thereof.

According to the present disclosure, the additional pigmented coating (iii) may comprise polyurethane, polycarbonate, a copolymer thereof, or a mixture thereof.

The additional pigmented coating (iii) may comprise a white pigment. The white pigment may comprise zinc white, lithopone, titanium dioxide, calcium carbonate (chalk), barium sulphate, or combinations thereof. The additional pigmented coating (iii) may comprise a white coloration. The additional pigmented coating (iii) may have a whiteness index of at least 70%, such as at least 75%, or at least 80%, as determined according to ASTM E313-20.

According to the present disclosure, the additional pigmented coating (iii) may have a dry film thickness of at least 3 μm, such as at least 5 μm, or at least 7 μm, or at least 10 μm. The additional pigmented coating (iii) may have a dry film thickness of 100 μm or less, such as 80 μm or less, or 70 μm or less, or 60 μm or less, or 50 μm or less. The additional pigmented coating (iii) may have a dry film thickness in a range between any of the above-mentioned values such as from 3 to 100 μm, or from 5 to 50 μm. The thickness can be determined according to DIN EN ISO 2178:2016. As used herein, the “dry film thickness” is the thickness of a coating, which is applied to at least a part of a surface of a substrate, measured above the substrate after the coating is cured.

According to the present disclosure, a pigmented coating (ii) is applied on the porous substrate (i); or, if an additional pigmented coating (iii) is present, on the additional pigmented coating (iii). The pigmented coating (ii) may be applied on the entire surface of the porous substrate (i) or the pigmented coating (ii) may be applied only on defined parts of the surface of the porous substrate (i). The pigmented coating (ii) may not be applied on the entire surface of the porous substrate (i).

According to the present disclosure, the pigmented coating (ii) may comprise poly(meth)acrylate, polyolefin, polyester, polysiloxane, epoxy resin, polyurethane, polyamide, polycarbonate, polyisocyanate, polyol, a copolymer thereof, or a mixture thereof.

Suitable examples of a poly(meth)acrylate, a polyolefin, a polyester, a polysiloxane, an epoxy resin, a polyurethane, a polyamide, a polycarbonate, polyisocyanate, or polyol may be as described above. Suitable examples of polyurethane and copolymer thereof include, but are not limited to, polyurethanes as described in, e.g., EP 0 260 447 A1, EP 0 089 497 A1, EP 0 256 540 A1, EP 0 297 576 A1, WO 96/12747, EP 0 228 003 A1, EP 0 397 806 A1, EP 0 574 417 A1, EP 0 531 510 A1, EP 0 581 211 A1 or EP 0 708 788 A1. Moreover, suitable examples of polyurethanes include, but are not limited to the reaction product of NCO-functional polyurethanes with OH-functional compounds such as with OH-functional polyesters, as described, e.g., in WO 2011/120940 A1. Especially suitable are polyurethanes derivable from an OH-functional component A containing double bonds, an NCO-functional component B containing double bonds, and optionally a component C containing double bonds as described in WO 2009/024310 A2, especially on page 3, first paragraph to page 5, fourth paragraph of WO 2009/024310 A2. Component A may be a polyol, and component B and C may be urethane acrylates. According to the present disclosure, the pigmented coating (ii) may comprise polyurethane, polycarbonate, a copolymer thereof, or a mixture thereof.

According to the present disclosure, the pigmented coating (ii) may have a dry film thickness of at least 3 μm, such as at least 5 μm, or at least 7 μm, or at least 10 μm. The pigmented coating (ii) may have a dry film thickness of 100 μm or less, such as 80 μm or less, or 70 μm or less, or 60 μm or less, or 50 μm or less. The pigmented coating (ii) may have a dry film thickness in a range between any of the above-mentioned values such as from 3 to 100 μm, or from 5 to 50 μm. The thickness can be determined according to DIN EN ISO 2178:2016. As used herein, the “dry film thickness” is the thickness of a coating, which is applied to at least a part of a surface of a substrate, measured above the substrate after the coating is cured.

The pigmented coating (ii) may comprise a color pigment. Examples of suitable color pigments include, but are not limited to, carbazole dioxazine pigments, azo pigments, monoazo pigments, diazo pigments, naphthol AS pigments, salt type (lakes) pigments, benzimidazolone pigments, metal complex pigments, isoindolinone pigments, isoindoline pigments, polycyclic phthalocyanine pigments, quinacridone pigments, perylene pigments, perinone pigments, diketopyrrolo pyrrole pigments, thioindigo pigments, anthraquinone pigments, indanthrone pigments, anthrapyrimidine pigments, flavanthrone pigments, pyranthrone pigments, anthanthrone pigments, dioxazine pigments, triarylcarbonium pigments, quinophthalone pigments, diketo pyrrolo pyrrole red (“DPPBO red”), charcoal, lamp black, carbon black, furnace black, graphite, graphene, vine black, perylene black, iron oxide black, or a mixture thereof. According to the present disclosure, the pigmented coating (ii) may comprise a black coloration. The pigmented coating (ii) may comprise a black pigment. The pigmented coating (ii) may comprise charcoal, lamp black, carbon black, furnace black, graphite, graphene, vine black, perylene black, iron oxide black, or a mixture thereof.

The pigmented coating (ii) of the present disclosure may be opaque. As used herein, the term “opaque” refers to a coating that does not transmit light in a wavelength of visible light. The transmittance can be measured according to DIN EN ISO 13468-2:2022.

According to the present disclosure, the light-blocking substrate (b) may comprise a perforation. As used herein, the term “perforation” refers to a cutout, an opening, a hole, or the like in the direction of the porous substrate (i) to the pigmented coating (ii) of the light-blocking substrate.

According to the present disclosure, the light-blocking substrate (b) is applied on the substrate (a), with the pigmented coating (ii) of the light-blocking substrate (b) facing the surface of the substrate (a).

The substrate (a) may comprise a light-transmitting material. The substrate (a) may include a glass, a polymer, or combinations thereof.

The substrate (a) may comprise a fluoropolymer, a polyethylene terephthalate, a polybutylene terephthalate, a polyolefin, a polycarbonate, a polyacrylate, a polystyrene, a polymethyl(meth)acrylate, an acrylonitrile butadiene styrene copolymer, an acrylonitrile butadiene styrene copolymer blend with polycarbonate, an acrylonitrile styrene acrylate copolymer, an acrylonitrile styrene acrylate copolymer blend with polycarbonate, a polycarbonate blend with polybutylene terephthalate, a copolymer thereof, or a mixture thereof. The substrate (a) may comprise a polycarbonate.

According to the present disclosure, the substrate (a) may have a thickness of at least 3 μm, such as at least 5 μm, or at least 7 μm, or at least 10 μm, or at least 15 μm. The substrate (a) may have a thickness of 1,500 μm or less, such as 1,300 μm or less, or 1,200 μm or less, or 1,000 μm or less, or 500 μm or less. The substrate (a) may have a thickness in a range between any of the above-mentioned values such as from 10 to 1,500 μm, or from 10 to 1,000 μm. The thickness can be determined according to DIN EN ISO 2178:2016.

The substrate (a) may be transparent. As used herein, the term “transparent” refers to a substrate that is light-transmissive and/or UV-transmissive. For example, the substrate (a) may transmit light in the visible light wavelength region in an amount of at least 5% on average, the transmittance can be measured according to DIN EN ISO 13468-2:2022.

The substrate (a) may be colored or colorless. The substrate (a) may comprise a pigment. Examples of suitable pigments include, but are not limited to, carbazole dioxazine pigments, azo pigments, monoazo pigments, diazo pigments, naphthol AS pigments, salt type (lakes) pigments, benzimidazolone pigments, metal complex pigments, isoindolinone pigments, isoindoline pigments, polycyclic phthalocyanine pigments, quinacridone pigments, perylene pigments, perinone pigments, diketopyrrolo pyrrole pigments, thioindigo pigments, anthraquinone pigments, indanthrone pigments, anthrapyrimidine pigments, flavanthrone pigments, pyranthrone pigments, anthanthrone pigments, dioxazine pigments, triarylcarbonium pigments, quinophthalone pigments, diketo pyrrolo pyrrole red (“DPPBO red”), titanium dioxide, carbon black or mixtures thereof. The substrate (a) may comprise an effect pigment. As used herein, the term “effect pigments” relates to pigments that impart visual effects to the composition or the cured coating. Suitable effect pigments may include, but are not limited to, metal effect pigments and pearlescent pigments, for example mica, aluminum oxide platelets, glass flakes or mixtures thereof.

According to the present disclosure, the substrate (a) may be a polymer film, more particularly a single-layer or a multi-layer polymer film. Reference may also be made to WO 2009/024310 A2, especially to page 6, fourth paragraph to page 7, fifth paragraph of WO 2009/024310 A2.

Prior to the application of the light-blocking substrate (b), the surface of the substrate (a) may be subjected to an activating pretreatment, such as a corona treatment and the like.

It was found that the light-blocking substrate provides good adhesion to the substrate (a) as well as to the optional plastic layer (c). Moreover, the light-blocking layer (b) provides good shielding as well as reflectivity ability. In addition, it was found that the preparation of the laminate substrate prevents an additional manufacturing step, such as printing of screen print layers, which requires long drying times.

According to the present disclosure, the laminate substrate may further comprise a layer having color-imparting properties between the substrate (a) and the light-blocking substrate (b). The layer having color-imparting properties may comprise pigments. Suitable pigments can include those described above, in particular for the substrate (a). The layer having color-imparting properties may comprise poly(meth)acrylate, polyolefin, polyester, polysiloxane, epoxy resin, polyurethane, polyamide, polycarbonate, polyisocyanate, polyol, a copolymer thereof, or a mixture thereof.

According to the present disclosure, the laminate substrate may further comprise a plastic layer (c). The light-blocking substrate (b) may be applied on a part of a surface of the plastic layer (c) with the porous substrate (i) facing the surface of the plastic layer (c). Such applying results in a laminate structure comprising a layer sequence of substrate (a); pigmented coating (ii), if present, additional pigmented coating (iii); porous substrate (i); and plastic layer (c).

The plastic layer (c) may comprise a fluoropolymer, a polyethylene terephthalate, a polybutylene terephthalate, a polyolefin, a polycarbonate, a polyacrylate, a polystyrene, a polymethyl(meth)acrylate, an acrylonitrile butadiene styrene copolymer, an acrylonitrile butadiene styrene copolymer blend with polycarbonate, an acrylonitrile styrene acrylate copolymer, an acrylonitrile styrene acrylate copolymer blend with polycarbonate, a polycarbonate blend with polybutylene terephthalate, a copolymer thereof, or a mixture thereof. The plastic layer (c) may comprise a polycarbonate.

The plastic layer (c) may be transparent. As used herein, the term “transparent” refers to a layer that is light-transmissive and/or UV-transmissive. For example, the plastic layer (c) may transmit light in the visible light wavelength region in an amount of at least 5% on average, the transmittance can be measured according to DIN EN ISO 13468-2:2022. The plastic layer (c) may be colorless.

The present disclosure further relates to a method for preparing a laminate substrate, such as a laminate substrate as described above. The method comprises applying a light-blocking substrate (b) on a part of a surface of a substrate (a). The light-blocking substrate (b) comprises (i) a porous substrate (i); and (ii) a pigmented coating (ii) applied on a the porous substrate (i). The light-blocking substrate (b) is applied on the substrate (a) with the pigmented coating (ii) facing the surface of the substrate (a). Such applying of the light-blocking substrate (b) on the substrate (a) results in a laminate structure comprising a layer sequence of substrate (a), pigmented coating (ii), and porous substrate (i).

The substrate (a) and the light-blocking substrate (b) comprising the porous substrate (i), and the pigmented coating (ii) may be any of the substrate (a) and the light-blocking substrate (b) comprising the porous substrate (i), and the pigmented coating (ii) as described above.

According to the present disclosure, the light-blocking substrate (b) may further comprise an additional pigmented coating (iii) between the porous substrate (i) and the pigmented coating (ii). If present, the additional pigmented coating (iii) can be applied on the porous substrate (i), and the pigmented coating (ii) can be applied on the additional pigmented surface (iii).

The additional coating (iii) can be as any one of the additional coating (iii) as described above.

According to the disclosure, the additional pigmented coating (iii) may be applied to the porous substrate (i) by any means standard in the art, such as by brushing, spraying, dipping, printing, flowing, and the like of a coating composition resulting in the coating when dried and/or cured. Spraying may be accomplished by compressed air spraying or electrostatic spraying. The additional pigmented coating (iii) may be applied to the porous substrate (i) to obtain a dry film thickness of at least 3 μm, such as at least 5 μm, or at least 7 μm, or at least 10 μm. The additional pigmented coating (iii) may be applied to the porous substrate (i) to obtain a dry film thickness of 100 μm or less, such as 80 μm or less, or 70 μm or less, or 60 μm or less, or 50 μm or less. The additional pigmented coating (iii) may be applied to the porous substrate (i) to obtain a dry film thickness in a range between any of the above-mentioned values such as from 3 to 100 μm, or from 5 to 50 μm. The thickness can be determined according to DIN EN ISO 2178:2016. As used herein, the “dry film thickness” is the thickness of a coating, which is applied to at least a part of a surface of a substrate, measured above the substrate after the coating is cured.

The additional pigmented coating (iii) may be applied on the entire surface of the porous substrate (i) or the additional pigmented coating (iii) may be applied only on defined parts of the surface of the porous substrate (i). The additional pigmented coating (iii) may not be applied on the entire surface of the porous substrate (i).

The additional pigmented coating (iii) may be cured by thermally curing and/or by radiation curing, such as UV-curing. The temperature for thermally curing the additional pigmented coating (iii) may be at least 40° C., such as at least 60° C., such as at least 80° C. The curing temperature may be 200° C. or less, such as 150° C. or less, such as 130° C. or less, such as 110° C. or less. The temperature for curing the additional pigmented coating (iii) may be from 40° C. to 200° C., such as from 40° C. to 180° C., such as from 80° C. to 180° C., such as from 80° C. to 130° C., such as from 80° C. to 110° C. The additional pigmented coating (iii) may be cured for at least 2 min, such as for at least 5 min, such as for at least 10 min, such as for at least 15 min, such as for at least 20 min, such as for 45 min or less, such as for 40 min or less, such as for 35 min or less, such as for 25 min or less, such as for 20 min or less. The time for curing the additional pigmented coating (iii) may be in a range between any of the above-mentioned values, such as from 2 min to 45 min, such as from 5 min to 40 min, such as from 10 min to 35 min, such as from 15 min to 30 min, such as from 20 min to 25 min.

The terms “cure”, “cured” or similar terms, as used in connection with the coating described herein, means that at least a portion of the components that form the coating composition is dried and/or crosslinked to form a coating.

According to the disclosure, the pigmented coating (ii) may be applied to the porous substrate (i); or if an additional pigmented coating (iii) is present, on the additional pigmented coating (iii) by any means standard in the art, such as by brushing, spraying, dipping, printing, flowing, and the like of a coating composition resulting in the coating when dried and/or cured. The pigmented coating (ii) may be applied to the porous substrate (i); or if an additional pigmented coating (iii) is present, on the additional pigmented coating (iii) to obtain a dry film thickness of at least 3 μm, such as at least 5 μm, or at least 7 μm, or at least 10 μm. The pigmented coating (ii) may be applied to the porous substrate (i); or if an additional pigmented coating (iii) is present, on the additional pigmented coating (iii) to obtain a dry film thickness of 100 μm or less, such as 80 μm or less, or 70 μm or less, or 60 μm or less, or 50 μm or less. The pigmented coating (ii) may be applied to the porous substrate (i); or if an additional pigmented coating (iii) is present, on the additional pigmented coating (iii) to obtain a dry film thickness in a range between any of the above-mentioned values such as from 3 to 100 μm, or from 5 to 50 μm. The thickness can be determined according to DIN EN ISO 2178:2016. As used herein, the “dry film thickness” is the thickness of a coating, which is applied to at least a part of a surface of a substrate, measured above the substrate after the coating is cured.

The pigmented coating (ii) may be applied on the entire surface of the porous substrate (i) or the pigmented coating (ii) may be applied only on defined parts of the surface of the porous substrate (i). The pigmented coating (ii) may not be applied on the entire surface of the porous substrate (i). If the additional coating (iii) is present, the pigmented coating (ii) may be applied on the entire surface of the additional coating (iii) or the pigmented coating (ii) may be applied only on defined parts of the surface of the additional coating (iii). If the additional coating (iii) is present, the pigmented coating (ii) may not be applied on the entire surface of the additional coating (iii).

The pigmented coating (ii) may be cured by thermally curing and/or by radiation curing, such as UV-curing. The temperature for thermally curing the pigmented coating (ii) may be at least 40° C., such as at least 60° C., such as at least 80° C. The curing temperature may be 200° C. or less, such as 150° C. or less, such as 130° C. or less, such as 110° C. or less. The temperature for curing the pigmented coating (ii) may be from 40° C. to 200° C., such as from 40° C. to 180° C., such as from 80° C. to 180° C., such as from 80° C. to 130° C., such as from 80° C. to 110° C. The pigmented coating (ii) may be cured for at least 2 min, such as for at least 5 min, such as for at least 10 min, such as for at least 15 min, such as for at least 20 min, such as for 45 min or less, such as for 40 min or less, such as for 35 min or less, such as for 25 min or less, such as for 20 min or less. The time for curing the pigmented coating (ii) may be in a range between any of the above-mentioned values, such as from 2 min to 45 min, such as from 5 min to 40 min, such as from 10 min to 35 min, such as from 15 min to 30 min, such as from 20 min to 25 min.

The light-blocking substrate (b) may comprise a perforation. The perforation may be obtained by cutting, lasering or the like.

The light-blocking substrate (b) is applied on the substrate (a) with the pigmented coating (ii) facing the surface of the substrate (a). The light-blocking substrate (b) may be cut into any shape needed. The light-blocking substrate (b) may be applied on the entire surface of the substrate (a) or the light-blocking substrate (b) may be applied on defined parts of the surface of the substrate (a). The light-blocking substrate (b) may not be applied on the entire surface of the substrate (a). If the light-blocking substrate (b) is applied on the entire surface of the substrate (a), the light-blocking substrate (b) typically comprises a perforation.

According to the present disclosure the light-blocking substrate (b) may be applied on a part of the surface of the substrate (a) by adhesive bonding or by lamination. Adhesive bonding may be obtained by applying a layer of an adhesive on the surface of the pigmented coating (ii) of the light-blocking substrate (b) and/or on the surface of the substrate (a). The adhesive may comprise a polyurethane. The light-blocking substrate (b) may be applied on a part of the surface of the substrate (a) by lamination. The light-blocking substrate (b) may further be applied on a part of the surface of the substrate (a) by injection back molding or foam backing. The temperature for lamination may be at least 60° C., such as at least 70° C., such as at least 80° C. The temperature for lamination may be 150° C. or less, such as 120° C. or less. The temperature for lamination may be from 60 to 150° C., such as 80 to 120° C.

Prior to the application of the light-blocking substrate (b), the surface of the substrate (a) may be subjected to an activating pretreatment, such as a corona treatment and the like.

According to the present disclosure, the laminate substrate may further comprise a layer having color-imparting properties between the substrate (a) and the light-blocking substrate (b). A layer having color-imparting properties may be applied on the substrate (a) and the light-blocking substrate (b) may be applied on the layer having color-imparting properties with the pigmented coating (ii) facing the surface of the layer having color-imparting properties. The layer having color-imparting properties may be applied by any means standard in the art, such as by brushing, spraying, dipping, printing, flowing, and the like.

The present disclosure further relates to a laminate substrate prepared by the method as described above.

The present disclosure further relates to a method for preparing a molded laminate substrate comprising thermoforming the laminate substrate as described above or prepared by the method as described above.

The method for preparing a molded laminate substrate further comprises injection back molding or casting with a plastic material forming a plastic layer (c) behind the laminate substrate on the surface of the laminate substrate comprising the light-blocking substrate with the porous substrate (i) facing the plastic layer (c). Such application results in a molded laminate structure comprising a layer sequence of substrate (a); pigmented coating (ii); if present, additional pigmented coating (iii); porous substrate (i); and plastic layer (c).

The plastic material may comprise a fluoropolymer, a polyethylene terephthalate, a polybutylene terephthalate, a polyolefin, a polycarbonate, a polyacrylate, a polystyrene, a polymethyl(meth)acrylate, an acrylonitrile butadiene styrene copolymer, an acrylonitrile butadiene styrene copolymer blend with polycarbonate, an acrylonitrile styrene acrylate copolymer, an acrylonitrile styrene acrylate copolymer blend with polycarbonate, a polycarbonate blend with polybutylene terephthalate, a copolymer thereof, or a mixture thereof. The plastic material may comprise a polycarbonate.

The plastic layer (c) may comprise a fluoropolymer, a polyethylene terephthalate, a polybutylene terephthalate, a polyolefin, a polycarbonate, a polyacrylate, a polystyrene, a polymethyl(meth)acrylate, an acrylonitrile butadiene styrene copolymer, an acrylonitrile butadiene styrene copolymer blend with polycarbonate, an acrylonitrile styrene acrylate copolymer, an acrylonitrile styrene acrylate copolymer blend with polycarbonate, a polycarbonate blend with polybutylene terephthalate, a copolymer thereof, or a mixture thereof. The plastic layer (c) may comprise a polycarbonate.

In automotive applications, the laminate substrate according to the present disclosure provides components that can be backlit, allowing light to pass through the component and especially through transparent areas of the component. The transparent areas may be colored so that day-time and night-time designs of the component can be achieved.

The present disclosure also relates to a molded laminate substrate prepared by the method for preparing a molded laminate substrate as described above.

According to the present disclosure, the laminate substrate may comprise an automobile part, such as a front panel, a rear panel, a side window, or a roof top.

The laminate substrate and/or the molded laminate substrate of the present disclosure may be used for automobile parts, such as a front panel, a rear panel, a side window, or a roof top.

### ASPECTS

The following clauses summarize some aspects of the present application.

A first aspect of the present application relates to a laminate substrate for use in automotive applications comprising:
(a) a substrate (a); and
(b) a light-blocking substrate (b) comprising:
(i) a porous substrate (i); and
(ii) a pigmented coating (ii) applied on the porous substrate (i);
wherein the light-blocking substrate (b) is applied on the substrate (a), with the pigmented coating (ii) facing the surface of the substrate (a).

A second aspect of the present application relates to the laminate substrate according to the first aspect, wherein the porous substrate (i) comprises a polyolefin, a polyester, a polyamide, a polyurethane, a polyurea, a polycarbonate, a polysiloxane, a poly(meth)acrylate, a copolymer thereof, or a mixture thereof.

A third aspect of the present application relates to the laminate substrate according to any one of the preceding aspects, wherein the porous substrate (i) comprises a polyolefin.

A fourth aspect of the present application relates to the laminate substrate according to any one of the preceding aspects, wherein the porous substrate (i) comprises an inorganic filler.

A fifth aspect of the present application relates to the laminate substrate according to fourth aspect, wherein the inorganic filler comprises silica, alumina, calcium oxide, zinc oxide, magnesium oxide, titanium oxide, zirconium oxide, or a mixture thereof.

A sixth aspect of the present application relates to the laminate substrate according to the fourth or fifth aspect, wherein the inorganic filler comprises silica.

A seventh aspect of the present application relates to the laminate substrate according to any one of the preceding aspects, wherein the porous substrate (i) has a thickness in a range of from 100 μm to 600 μm, measured according to ASTM D-374-16.

An eighth aspect of the present application relates to the laminate substrate according to any one of the preceding aspects, wherein the substrate (a) comprises a fluoropolymer, a polyethylene terephthalate, a polybutylene terephthalate, a polyolefin, a polycarbonate, a polyacrylate, a polystyrene, a polymethyl(meth)acrylate, an acrylonitrile butadiene styrene copolymer, an acrylonitrile butadiene styrene copolymer blend with polycarbonate, an acrylonitrile styrene acrylate copolymer, an acrylonitrile styrene acrylate copolymer blend with polycarbonate, a polycarbonate blend with polybutylene terephthalate, a copolymer thereof, or a mixture thereof.

A ninth aspect of the present application relates to the laminate substrate according to any one of the preceding aspects, wherein the substrate (a) comprises a polycarbonate.

A tenth aspect of the present application relates to the laminate substrate according to any one of the preceding aspects, wherein the substrate (a) is transparent.

An eleventh aspect of the present application relates to the laminate substrate according to any one of the preceding aspects, wherein the substrate (a) has a thickness in a range of from 10 to 1,500 μm, such as 10 to 1,000 μm, measured according to DIN EN ISO2178:2016.

A twelfth aspect of the present application relates to the laminate substrate according to any one of the preceding aspects, wherein the substrate (a) is a polymer film.

A thirteenth aspect of the present application relates to the laminate substrate according to any one of the preceding aspects, wherein the light-blocking substrate (b) further comprises an additional pigmented coating (iii) between the porous substrate (i) and the pigmented coating (ii).

A fourteenth aspect of the present application relates to the laminate substrate according to the thirteenth aspect, wherein the additional pigmented coating (iii) comprises a white pigment.

A fifteenth aspect of the present application relates to the laminate substrate according to any one of the thirteenth to fourteenth aspects, wherein the additional pigmented coating (iii) comprises poly(meth)acrylate, polyolefin, polyester, polysiloxane, epoxy resin, polyurethane, polyamide, polycarbonate, polyisocyanate, polyol, a copolymer thereof, or a mixture thereof.

A sixteenth aspect of the present application relates to the laminate substrate according to any one of the thirteenth to fifteenth aspects, wherein the additional pigmented coating (iii) comprises polyurethane, polycarbonate, a copolymer thereof, or a mixture thereof.

A seventeenth aspect of the present application relates to the laminate substrate according to any one of the thirteenth to sixteenth aspects, wherein the additional pigmented coating (iii) has a dry film thickness in a range of from 3 to 100 μm, such as from 5 to 50 μm, measured according to DIN EN ISO 2178:2016.

An eighteenth aspect of the present application relates to the laminate substrate according to any one of the preceding aspects, wherein the pigmented coating (ii) comprises poly(meth)acrylate, polyolefin, polyester, polysiloxane, epoxy resin, polyurethane, polyamide, polycarbonate, polyisocyanate, polyol, a copolymer thereof, or a mixture thereof.

A nineteenth aspect of the present application relates to the laminate substrate according to any one of the preceding aspects, wherein the pigmented coating (ii) comprises polyurethane, polycarbonate, a copolymer thereof, or a mixture thereof.

A twentieth aspect of the present application relates to the laminate substrate according to any one of the preceding aspects, wherein the pigmented coating (ii) has a dry film thickness in a range of from 3 to 100 μm, such as from 5 to 50 μm, measured according to DIN EN ISO 2178:2016.

A twenty-first aspect of the present application relates to the laminate substrate according to any one of the preceding aspects, wherein the pigmented coating (ii) comprises a black pigment.

A twenty-second aspect of the present application relates to the laminate substrate according to any one of the preceding aspects, wherein the pigmented coating (ii) comprises charcoal, lamp black, carbon black, furnace black, graphite, graphene, vine black, perylene black, iron oxide black, or a mixture thereof.

A twenty-third aspect of the present application relates to the laminate substrate according to any one of the preceding aspects, wherein the pigmented coating (ii) is opaque.

A twenty-fourth aspect of the present application relates to the laminate substrate according to any one of the preceding aspects, wherein the light-blocking substrate (b) comprises a perforation.

A twenty-fifth aspect of the present application relates to the laminate substrate according to any one of the preceding aspects further comprising a plastic layer (c), wherein light-blocking substrate (b) may be applied on the plastic layer (c) with the porous substrate (i) facing the surface of the plastic layer (c).

A twenty-sixth aspect of the present application relates to a method for preparing a laminate substrate comprising:
applying a light-blocking substrate (b) on a substrate (a), wherein the light-blocking substrate (b) comprises:
(i) a porous substrate (i); and
(ii) a pigmented coating (ii) applied on the porous substrate (i);
wherein the light-blocking substrate (b) is applied on the substrate (a) with the pigmented coating (ii) facing the surface of the substrate (a).

A twenty-seventh aspect of the present application relates to the method according to the twenty-sixth aspect, wherein the light-blocking substrate (b) is applied on the substrate (a) by lamination.

A twenty-eighth aspect of the present application relates to the method according to any one of the twenty-sixth to twenty-seventh aspects, wherein the porous substrate (i) comprises a polyolefin, a polyester, a polyamide, a polyurethane, a polyurea, a polycarbonate, a polysiloxane, a poly(meth)acrylate, a copolymer thereof, or a mixture thereof.

A twenty-ninth aspect of the present application relates to the method according to any one of the twenty-sixth to twenty-eighth aspects, wherein the porous substrate (i) comprises a polyolefin.

A thirtieth aspect of the present application relates to the method according to any one of the twenty-sixth to twenty-ninth aspects, wherein the porous substrate (i) comprises an inorganic filler.

A thirty-first aspect of the present application relates to the method according to the thirtieth aspect, wherein the inorganic filler comprises silica, alumina, calcium oxide, zinc oxide, magnesium oxide, titanium oxide, zirconium oxide, or a mixture thereof.

A thirty-second aspect of the present application relates to the method according to the thirtieth or thirty-first aspect, wherein the inorganic filler comprises silica.

A thirty-third aspect of the present application relates to the method according to any one of the thirtieth to thirty-second aspect, wherein the porous substrate (i) has a thickness in a range of from 100 μm to 600 μm, measured according to ASTM D-374-16.

A thirty-fourth aspect of the present application relates to the method according to any one of the twenty-sixth to thirty-third aspects, wherein the substrate (a) comprises a fluoropolymer, a polyethylene terephthalate, a polybutylene terephthalate, a polyolefin, a polycarbonate, a polyacrylate, a polystyrene, a polymethyl(meth)acrylate, an acrylonitrile butadiene styrene copolymer, an acrylonitrile butadiene styrene copolymer blend with polycarbonate, an acrylonitrile styrene acrylate copolymer, an acrylonitrile styrene acrylate copolymer blend with polycarbonate, a polycarbonate blend with polybutylene terephthalate, a copolymer thereof, or a mixture thereof.

A thirty-fifth aspect of the present application relates to the method according to any one of the twenty-sixth to thirty-fourth aspects, wherein the substrate (a) comprises a polycarbonate.

A thirty-sixth aspect of the present application relates to the method according to any one of the twenty-sixth to thirty-fifth aspects, wherein the substrate (a) is transparent.

A thirty-seventh aspect of the present application relates to the method according to any one of the twenty-sixth to thirty-sixth aspects, wherein the substrate (a) has a thickness in a range of from 10 to 1,500 μm, such as 10 to 1,000 μm, measured according to DIN EN ISO 2178:2016.

A thirty-eighth aspect of the present application relates to the method according to any one of the twenty-sixth to thirty-seventh aspects, wherein the substrate (a) is a polymer film.

A thirty-ninth aspect of the present application relates to the method according to any one of the twenty-sixth to thirty-eighth aspects, wherein the light-blocking substrate (b) further comprises an additional pigmented coating (iii) between the porous substrate (i) and the pigmented coating (ii).

A fortieth aspect of the present application relates to the method according to the thirty-ninth aspect, wherein the additional pigmented coating (iii) comprises a white pigment.

A forty-first aspect of the present application relates to the method according to any one of the thirty-ninth to fortieth aspects, wherein the additional pigmented coating (iii) comprises poly(meth)acrylate, polyolefin, polyester, polysiloxane, epoxy resin, polyurethane, polyamide, polycarbonate, polyisocyanate, polyol, a copolymer thereof, or a mixture thereof.

A forty-second aspect of the present application relates to the method according to any one of the thirty-ninth to forty-first aspects, wherein the additional pigmented coating (iii) comprises polyurethane, polycarbonate, a copolymer thereof, or a mixture thereof.

A forty-third aspect of the present application relates to the method according to any one of the thirty-ninth to forty-third aspects, wherein the additional pigmented coating (iii) has a dry film thickness in a range of from 3 to 100 μm, such as from 5 to 50 μm, measured according to DIN EN ISO 2178:2016.

A forty-fourth aspect of the present application relates to the method according to any one of the twenty-sixth to forty-third aspects, wherein the pigmented coating (ii) comprises poly(meth)acrylate, polyolefin, polyester, polysiloxane, epoxy resin, polyurethane, polyamide, polycarbonate, polyisocyanate, polyol, a copolymer thereof, or a mixture thereof.

A forty-fifth aspect of the present application relates to the method according to any one of the twenty-sixth to forty-fourth aspects, wherein the pigmented coating (ii) comprises polyurethane, polycarbonate, a copolymer thereof, or a mixture thereof.

A forty-sixth aspect of the present application relates to the method according to any one of the twenty-sixth to forty-fifth aspects, wherein the pigmented coating (ii) has a dry film thickness in a range of from 3 to 100 μm, such as from 5 to 50 μm, measured according to DIN EN ISO 2178:2016.

A forty-seventh aspect of the present application relates to the method according to any one of the twenty-sixth to forty-sixth aspects, wherein the pigmented coating (ii) comprises a black pigment.

A forty-eighth aspect of the present application relates to the method according to any one of the twenty-sixth to forty-seventh aspects, wherein the pigmented coating (ii) comprises charcoal, lamp black, carbon black, furnace black, graphite, graphene, vine black, perylene black, iron oxide black, or a mixture thereof.

A forty-ninth aspect of the present application relates to the method according to any one of the twenty-sixth to forty-eighth aspects, wherein the pigmented coating (ii) is opaque.

A fiftieth aspect of the present application relates to the method according to any one of the twenty-sixth to forty-ninth aspects, wherein the light-blocking substrate (b) comprises a perforation.

A fifty-first aspect of the present application relates to a laminate substrate prepared by the method according to any one of the twenty-sixth to fiftieth aspects.

A fifty-second aspect of the present application relates to a method for preparing a molded laminate substrate comprising:
thermoforming the laminate substrate prepared by the method according to any one of the twenty-sixth to fiftieth aspects.

A fifty-third aspect of the present application relates to the method according to the fifty-second aspect, further comprising injection back molding or casting with a plastic material forming a plastic layer (c) behind the laminate substrate on the surface of the laminate substrate comprising the light-blocking substrate with the porous substrate (i) facing the plastic layer (c).

A fifty-fourth aspect of the present application relates to a molded laminate substrate prepared by the method according to any one of the fifty-second to fifty-third aspects.

1. A laminate substrate for use in automotive applications comprising:
(a) a substrate (a); and
(b) a light-blocking substrate (b) comprising:
(i) a porous substrate (i); and
(ii) a pigmented coating (ii) applied on the porous substrate (i);
wherein the light-blocking substrate (b) is applied on the substrate (a), with the pigmented coating (ii) facing the surface of the substrate (a).

2. The laminate substrate according to claim 1, wherein the porous substrate (i) comprises a polyolefin, a polyester, a polyamide, a polyurethane, a polyurea, a polycarbonate, a polysiloxane, a poly(meth)acrylate, a copolymer thereof, or a mixture thereof; and/or
wherein the porous substrate (i) has a thickness in a range of from 100 μm to 600 μm, measured according to ASTM D-374-16.

3. The laminate substrate according to claim 1, wherein the porous substrate (i) comprises an inorganic filler.

4. The laminate substrate according to claim 3, wherein the inorganic filler comprises silica, alumina, calcium oxide, zinc oxide, magnesium oxide, titanium oxide, zirconium oxide, or a mixture thereof.

5. The laminate substrate according to claim 1, wherein the substrate (a) comprises a fluoropolymer, a polyethylene terephthalate, a polybutylene terephthalate, a polyolefin, a polycarbonate, a polyacrylate, a polystyrene, a polymethyl(meth)acrylate, an acrylonitrile butadiene styrene copolymer, an acrylonitrile butadiene styrene copolymer blend with polycarbonate, an acrylonitrile styrene acrylate copolymer, an acrylonitrile styrene acrylate copolymer blend with polycarbonate, a polycarbonate blend with polybutylene terephthalate, a copolymer thereof, or a mixture thereof; and/or
wherein the substrate (a) is transparent.

6. The laminate substrate according to claim 1, wherein the substrate (a) has a thickness in a range of from 10 to 1,500 μm, measured according to DIN EN ISO2178:2016; and/or
wherein the substrate (a) is a polymer film.

7. The laminate substrate according to claim 1, wherein the light-blocking substrate (b) further comprises an additional pigmented coating (iii) between the porous substrate (i) and the pigmented coating (ii).

8. The laminate substrate according to claim 7, wherein the additional pigmented coating (iii) comprises a white pigment; and/or
wherein the additional pigmented coating (iii) comprises poly(meth)acrylate, polyolefin, polyester, polysiloxane, epoxy resin, polyurethane, polyamide, polycarbonate, polyisocyanate, polyol, a copolymer thereof, or a mixture thereof; and/or
wherein the additional pigmented coating (iii) has a dry film thickness in a range of from 3 to 100 μm, measured according to DIN EN ISO 2178:2016.

9. The laminate substrate according to claim 1, wherein the pigmented coating (ii) comprises poly(meth)acrylate, polyolefin, polyester, polysiloxane, epoxy resin, polyurethane, polyamide, polycarbonate, polyisocyanate, polyol, a copolymer thereof, or a mixture thereof; and/or
wherein the pigmented coating (ii) has a dry film thickness in a range of from 3 to 100 μm, measured according to DIN EN ISO 2178:2016.

10. The laminate substrate according to claim 1, wherein the pigmented coating (ii) comprises a black pigment; and/or
wherein the pigmented coating (ii) comprises charcoal, lamp black, carbon black, furnace black, graphite, graphene, vine black, perylene black, iron oxide black, or a mixture thereof; and or
wherein the pigmented coating (ii) is opaque.

11. The laminate substrate according to claim 1, wherein the light-blocking substrate (b) comprises a perforation.

12. The laminate substrate according to claim 1 further comprising a plastic layer (c), wherein the light-blocking substrate (b) may be applied on the plastic layer (c) with the porous substrate (i) facing the surface of the plastic layer (c).

13. A method for preparing a laminate substrate comprising:
applying a light-blocking substrate (b) on a substrate (a), wherein the light-blocking substrate (b) comprises:
(i) a porous substrate (i); and
(ii) a pigmented coating (ii) applied on the porous substrate (i);
wherein the light-blocking substrate (b) is applied on the substrate (a) with the pigmented coating (ii) facing the surface of the substrate (a).

14. The method according to claim 13, wherein the light-blocking substrate (b) is applied on the substrate (a) by lamination.

15. The method according to claim 13, wherein the light-blocking substrate (b) further comprises an additional pigmented coating (iii) between the porous substrate (i) and the pigmented coating (ii).

16. (canceled)

17. A laminate substrate prepared by the method according to claim 13.

18. A method for preparing a molded laminate substrate comprising:
thermoforming the laminate substrate prepared by the method according to claim 13.

19. The method according to claim 18, further comprising injection back molding or casting with a plastic material forming a plastic layer (c) behind the laminate substrate on the surface of the laminate substrate comprising the light-blocking substrate with the porous substrate (i) facing the plastic layer (c).

20. (canceled)
